(19) United States
(12) Patent Application Publication
(10) Pub. No.: US 2002/0115795 A1
(43) Pub. Date: Aug. 22, 2002

(54) Autoclavable, non-adherent, heat sealable polymer films for fabricating monolayer and multiple layered films and containers

(76) Inventors: Sherwin Shang, Vernon Hills, IL (US); Tahua Yang, Woodridge, IL (US); Michael T. K. Ling, Vernon Hills, IL (US); Lee Woo, Libertyville, IL (US); Jean-Claude Bonte, Lessines (BE); Michael Becker, Chicago, IL (US); Michael Masterson, Gurnee, IL (US); James J. Peterson, Lake Villa, IL (US); Craig Sandford, Buffalo Grove, IL (US)

Correspondence Address: CHARLES R. MATTENSON, ESQ., CORPORATE COUNSEL - RENAL DIVISION, BAXTER INTERNATIONAL INC., ONE BAXTER PARKWAY, DF3-3E, DEERFIELD, IL, 60015-4633, US

(21) Appl. No.: 09/917,136

(22) Filed: Jul. 27, 2001

Related U.S. Application Data
(63) Continuation-in-part of application No. 09/526,357, filed on Mar. 16, 2000.

(51) Int. Cl. C08F 8/00

(52) U.S. Cl. 525/192; 525/240

(57) ABSTRACT

The present invention provides polymer blends having a first component of a polymeric material capable of being cross-linked and selected from the group consisting of an ethylene containing polymer, the first component present in an amount by weight of the blend from about 50% to about 95%, the first component having a first melting point temperature determined by DSC; and a second component of a non-readily cross-linkable polymeric material and selected from the group consisting of propylene containing polymers and methyl pentene containing polymers, the second component being present in an amount by weight of the blend from about 50% to about 5%, the second component having a second melting point temperature determined by DSC; and a portion of the first component being cross-linked and the second component is essentially free of cross-linking.

### CROSS-REFERENCE TO RELATED APPLICATIONS

This is being filed as a Continuation-In-Part application of Ser. No. 09/526,357 filed on Mar. 16, 2000, which is incorporated

### FEDERALLY SPONSORED RESEARCH

Not Applicable.

### BACKGROUND OF THE INVENTION

### TECHNICAL FIELD

The present invention relates generally to polymer blends for fabricating films and more particularly films that have low distortion and are non-adherent upon steam sterilization, are heat sealable and are suitable for fabricating into flexible medical containers.

In the medical field, where beneficial agents are collected, processed and stored in containers, transported, and ultimately delivered through tubes by infusion to patients to achieve therapeutic effects, materials which are used to fabricate the containers must have a unique combination of properties. For example, visual inspection of solutions for particulate contamination requires an optically transparent container. The material which forms the wall must be sufficiently flexible to infuse a solution by collapsing the container walls, without introducing air into the container. The material must maintain its flexibility and toughness over a wide range of temperatures. The material must maintain its flexibility and toughness at low temperatures because some solutions, for example, certain premixed drug solutions, are stored and transported in containers at temperatures such as −25° C. to −30° C. to minimize the drug degradation. The material must also be functional and resist distortion at high temperatures to withstand the heat of steam sterilization; a process which most medical fluid containers and nutritional products are subjected to prior to shipment. The sterilization process usually includes exposing the container to steam at temperatures typically 121° C. and at elevated pressures.

For ease of manufacture into useful articles, it is desirable that the material be sealable using heat sealing techniques. The material therefore must maintain sufficient thermoplastic properties to melt upon heating.

A further requirement is to minimize the environmental impact upon the disposal of the article fabricated from the material after its intended use. For those articles that are disposed of in landfills, it is desirable to minimize or avoid the incorporation of low molecular weight leachable components to construct the article. Further benefits are realized by using a material that allows thermal reprocessing of scrap material produced during manufacturing.

For those containers that are disposed of through incineration to minimize biological hazards, it is desirable to use a material that minimizes or eliminates the formation of environmentally undesirable and corrosive inorganic acids. It is also desirable that the material be free from or have a low content of low molecular weight additives such as plasticizers, stabilizers and the like which could be released into the medications or biological fluids.

Due to its ability to meet a wide variety of functional requirements, flexible polyvinyl chloride (PVC) has frequently been the material of choice for medical bag applications. PVC also offers the distinct advantage of being one of the most cost-effective materials for constructing devices that meet the above requirements. However, PVC has a number of disadvantages in the marketplace. These disadvantages include incompatibility of PVC compounds with certain drugs, concerns regarding chlorine content and its effects on the environment and a growing negative market perception of PVC in general. Thus, many materials have been devised to replace PVC. However, most alternate materials are too expensive to implement and still do not meet all of the above requirements.

Polyolefins and polyolefin alloys have been developed which meet many of the requirements of medical containers and tubing, without the disadvantages associated with PVC. Polyolefins typically are compatible with medical applications because they have relatively low extractability to fluids. Most polyolefins are environmentally sound as they do not generate harmful degradants upon incineration, and are suitable for thermoplastic recycling. Many polyolefins are cost effective materials that may provide an economic alternative to PVC. However, there are many hurdles to overcome to replace all the favorable attributes of PVC with a polyolefin.

For example, problems have been encountered in using certain polyolefins to fabricate medical tubing. Such tubing has been found to have poor surface characteristics so that it is readily susceptible to cutting, shredding or scoring when clamping the tubing using a slide clamp. Also, certain polyolefins that have favorable modulus attributes, such as ultra-low density polyethylenes, have melting point temperatures below that reached during an autoclave process.

It is well known that cross-linking by chemical agents or by high energy ionizing radiation increases heat resistance of the polymer matrix. The chemical cross-links are covalent bonds across separate polymer chains that greatly retard the tendency to deform and flow at high temperatures—even above the melting point of the polymer. For example, U.S. Pat. No. 4,465,487 assigned to Terumo discloses fabricating steam autoclavable medical containers by irradiating ethylene vinyl acetate copolymers with high energy (2 Mev) electron beams at doses between 50 kGy and 100 kGy to achieve gel contents of between 50% and 85%. The '487 Patent discloses that if the EVA sidewalls of the container are irradiated to achieve a gel content of about 50% or higher before being sealed together they are easily peeled apart. (Col. 4, lines 20-30). Accordingly, the '487 Patent discloses irradiating the sidewalls of the container after sealing the container into a pouch leaving only a port area unsealed.

Similarly, U.S. Pat. No. 4,453,940 discloses fabricating medical containers from EVA and other materials. The '940 Patent also discloses the step of increasing the autoclave resistance of EVA by cross-linking the material with high energy electron beam. The '940 Patent warns that if the cross-linking exceeds 50% the use of heat sealing becomes impossible. (Col. 4, lines 27-35).

U.S. Pat. No. 4,401,536 discloses crosslinking semi-rigid containers composed of films of polypropylene and EVA or EEA. This patent does not disclose the use of ethylene alpha olefins with polypropylene. It also discloses that irradiation before forming results in articles with poor heat sealability (Col.4, lines 25-28).

U.S. Pat. Nos. 4,892,604 and 5,066,290 both assigned to the present assignee, disclose a medical container with a coextruded high density polyethylene skin layer and a core layer of an ethylene vinyl acetate copolymer having about 18% vinyl acetate content. After the container is fabricated by conventional radio frequency heat seal, the assembly is subjected to ionizing radiation of about 100 kGy from a high energy electron beam accelerator of about 5 Mev. The high density polyethylene layer acts as a moisture and gas transmission barrier to maintain the sterile fluid content at a relatively constant concentration as required by various pharmacopoeia of the world. However, several serious deficiencies were apparent in this material construction: 1) to fabricate a container from this material construction the container must be fabricated before the cross-linking process, since the cross-linked EVA layer is difficult if not impossible to seal (this renders the manufacturing process very inefficient); and 2) the radiation dose required for sufficient cross-linking also releases significant quantities of acetic acid—a by-product of the radiation exposure. Since the HDPE presents a barrier to gas transmission, the trapped acetic acid can render the fluid contents quite acidic—a very undesirable outcome.

U.S. Pat. No. 4,643,926 assigned to W. R. Grace discloses fabricating a medical solution container from a multilayered material where, in certain embodiments, the layer intended to be heat sealed is constructed with polypropylene as the main ingredient. Since it is well known that polypropylenes undergo chain scission when exposed to radiation, the heat seal layer remained thermoplastic and capable of being heat-sealed to similar surfaces. Therefore, the entire multilayer film can be heat-sealed and survive autoclaving. However, the complexity of the multilayer construction and the possible need of washing and incorporating acid scavenging compounds in the film (See U.S. Pat. No. 5,445,893) to remove the acidic by-products of irradiating EVA renders the process quite complicated and the cost very high. Further, since the film is constructed of several very dissimilar materials, process recycling of the edge trim and other film scraps is very difficult and impractical without greatly reducing the optical and mechanical properties.

U.S. Pat. No. 5,055,328 discloses a multilayer differentially cross-linked film where the heat-sealed layer contains additional antioxidants to retard cross-linking and to facilitate heat-sealing post cross-linking. Likewise, Canadian Patent 1,125,229 discloses another differential cross-linked multilayer film where the outer layer contains a cross-link enhancer. However, these constructions are all multilayer constructions and do not address the issue of self adhesion during autoclaving.

U.S. Pat. No. 4,724,176 to Sun discloses a multilayer, oriented, heat shrinkable container with a radiation cross-linked outer layer and, by controlling the irradiation process, a non cross-linked inner seal layer. The inner and outer layers can be of EVA copolymers. This container is designed to shrink upon application of heat, and, therefore, would be unsuitable for a container that must maintain substantially its entire volume after an autoclave process.

U.S. Pat. No. 4,550,141 discloses polymer blends of ionomers with propylene and α-olefin copolymers. The '141 Patent also discloses single-layered and multiple-layered films made from the blends. The '141 patent discloses forming peel seals using these films wherein it is desirable to have a consistent peel strength over a wide heat sealing temperature range (e.g., a range of at least 10° C.). The '141 Patent does not disclose exposing the blends or films to radiation to cause cross-linking. Further, the '141 Patent states that it is not an object to provide a peelable seal that is capable of withstanding steam sterilization (col. 1, lines 55-57).

The present invention provides polymeric materials that are, overall, superior to those materials, of which we are aware, which have been heretofore known in the art or have been commercially used or marketed. The properties of such materials include flexibility, optical transparency for visual inspection, and sufficient thermal resistance to withstand a steam sterilization process at temperatures up to 121° C. without experiencing significant distortion or self adhesion. The materials should also be non-oriented, non-adherent and capable of being sealed using heat sealing techniques. The materials should also be substantially free of low molecular weight leachable additives, and capable of safe disposal by incineration without the generation of significant amounts of corrosive inorganic acids. Finally, the material should serve as a cost-effective alternative to various PVC formulations currently being used for medical devices.

U.S. Pat. No. 5,879,768 discloses a pouch for packaging flowable materials fabricated from a material having a seal layer of a polymeric composition comprising: (A) 10 to 100 percent of a mixture of (1) from 5 to 95% of at least one homogeneously branched substantially linear ethylene/α-olefin interpolymer, and (2) from 5 to 95% of high pressure low density polyethylene having a density from 0.916-0.930 g/cc; and (B) from 0-90% of one polymer selected from the group consisting of an ultra low density polyethylene, a linear low density polyethylene, a high pressure low density polyethylene, an ethylene vinyl acetate copolymer, and a homogeneously branched linear ethylene polymer. The '768 Patent does not disclose exposing this film to radiation nor does it disclose blending the homogeneously branched, substantially linear ethylene/α-olefin interpolymer with polypropylene.

When more than one polymer is blended to form an alloying composition, it is difficult to achieve all of the above objectives simultaneously. For example, many alloys produce significant light scattering; thus, they fail to meet the optical clarity objective. The light scattering intensity (measured by haze) depends on the domain size of components in the micrometer (μ) range, and the proximity of the refractive indices of the components. As a general rule, the selection of components that can be satisfactorily processed into very small domain sizes, and yet with a minimum of refractive index mismatches, is a difficult task.

There are innumerable uses for such polymer films. One conventional use is to fabricate a peelable seal. A peelable seal is the seal or joint between two films produced by heat-sealing, or by any sealing method known in the art, the seal or joint thus formed having the property of being able to open in the original plane of the joining of the two films by a pulling force without destroying the integrity of the films or the peripheral/permanent seal. Prior to the present invention, peelable seals were formed by sealing multilayer films, as disclosed in U.S. Pat. Nos. 5,904,425; 5,893,645; and 5,887,980, which are incorporated herein by reference and made a part hereof. One problem, though, with current peelable seals is that the peel strength is unpredictable because of low manufacturing tolerances for processing window variances. For example, the peel strength could be excessively weak, which might not provide a hermetic seal, or excessively strong, which might be difficult to break.

U.S. Pat. Nos. 4,808,662 and 4,189,519 disclose a peelable seal characterized by a nearly constant peel strength over an extended sealing temperature range. A variety of other references disclose sealable films capable of forming peelable seals, such as U.S. Pat. Nos. 4,916,190; 4,784,885; 4,539,263; 4,414,053 and 3,879,492. However, none of the foregoing references teach forming a peelable seal from a monolayer film where the components of the film have distinct melting point temperatures, where the peelable seal has a nearly constant peel strength before and after autoclaving, and where the monolayer film forming the peelable seal can subsequently be formed into a container. The present invention is provided to solve these and other problems.

### SUMMARY OF THE INVENTION

The present invention provides polymer blends having a first component of a polymeric material capable of being cross-linked and selected from the group consisting of an ethylene containing polymer, the first component present in an amount by weight of the blend from about 50% to about 95%, the first component having a first melting point temperature determined by DSC; and a second component of a non-readily cross-linkable polymeric material and selected from the group consisting of propylene containing polymers and methyl pentene containing polymers, the second component being present in an amount by weight of the blend from about 50% to about 5%, the second component having a second melting point temperature determined by DSC; and a portion of the first component being cross-linked and the second component is essentially free of cross-linking.

### BRIEF DESCRIPTION OF THE DRAWINGS:

FIG. 1 is a cross-sectional view of a monolayer film of the present invention;

FIG. 2 is a cross-sectional view of a multiple layered film of the present invention;

FIG. 3 is a material container fabricated from a film of the present invention;

FIG. 4 is an I.V. fluid administration set;

FIG. 5 is a peritoneal dialysis container and tubing set;

FIG. 6 is a dual chamber bag with a peelable seal separating the chambers;

FIG. 7 shows a general DSC plot depicting a peel seal heat sealing window defined between two melting point temperatures;

FIG. 8 shows a cross-sectional view of a tubing of the present invention;

FIG. 9 shows a plot of peel seal force versus sealing temperature for a film before and after autoclaving process; and

FIG. 10 shows a graph showing average peel force versus sealing temperature for films having various degrees of surface roughness.

### DETAILED DESCRIPTION OF THE INVENTION

The present invention is susceptible of embodiments in many different forms. Preferred embodiments of the invention are disclosed with the understanding that the present disclosure is to be considered as an exemplification of the principles of the invention and is not intended to limit the broad aspects of the invention to the embodiments illustrated.

I. Polymer Blends and Monolayer Films Therefrom

a. First Polymer Blend

FIG. 1 shows a monolayer film 10 of the present invention. The monolayer film 10 is fabricated from a polymer blend having a first component and a second component. The first component is selected from the group of: (1) ethylene and α-olefin interpolymers having a density of less than about 0.915 g/cc, (2) ethylene and lower alkyl acrylate interpolymers, (3) ethylene and lower alkyl substituted alkyl acrylate interpolymers and (4) ionic polymers, commonly referred to as ionomers. The first component is present in an amount from about 99% to about 55% by weight of the film, more preferably from about 60%-85% and most preferably from about 65%-80%.

The second component is selected from the group consisting of: (1) propylene containing polymers, (2) butene containing polymers, (3) polymethyl pentene containing polymers, (4) cyclic olefin containing polymers and (5) bridged polycyclic hydrocarbon containing polymers. The second component is present in an amount by weight of the film from about 45% to about 1%, more preferably from about 15%-40% and most preferably from about 20%-35%.

The film has a modulus of elasticity when measured in accordance with ASTM D882 of less than about 60,000 psi, an internal haze when measured in accordance with ASTM D 1003 of less than about 25%, self adhesion ranking greater than about two (as defined below), slight or no adhesion to overpouch materials, has a sample creep at 120° C. at about 27 psi loading of less than or equal to 150%, and the film can be heat sealed into a container having seals wherein the seals remain intact when a liquid filled container is autoclaved at temperatures from about 100° C. to about 121° C. for one hour.

As used herein, the term “interpolymer” includes copolymers, terpolymers either random or block.

Suitable ethylene and α-olefin interpolymers preferably have a density, as measured by ASTM D-792 of less than about 0.915 g/cc and are commonly referred to as very low density polyethylene (VLDPE), ultra low density ethylene (ULDPE) and the like. The α-olefin should have from 3-17 carbons, more preferably from 4-12 and most preferably 4-8 carbons. In a preferred form of the invention, the ethylene and α-olefin copolymers are obtained using single site catalysts. Suitable single site catalyst systems, among others, are those disclosed in U.S. Pat. Nos. 5,783,638 and 5,272,236. Suitable ethylene and α-olefin copolymers include those sold by Dow Chemical Company under the AFFINITY tradename, Dupont-Dow under the ENGAGE tradename and Exxon under the EXACT and PLASTOMER tradenames.

The term “lower alkyl acrylates” refers to comonomers having the formula set forth in Diagram 1:

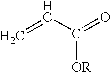

The R group refers to alkanes having from 1 to 17 carbons. Thus, the term “lower alkyl acrylates” includes but is not limited to methyl acrylate, ethyl acrylate, butyl acrylate and the like.

The term “alkyl substituted alkyl acrylates” refers to comonomers having the formula set forth in Diagram 2:

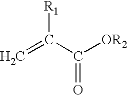

R₁ and R₂ are alkanes having 1-17 carbons and can have the same number of carbons or have a different number of carbons. Thus, the term “alkyl substituted alkyl acrylates” includes but is not limited to methyl methacrylate, ethyl methacrylate, methyl ethacrylate, ethyl ethacrylate, butyl methacrylate, butyl ethacrylate and the like.

Suitable propylene containing polymers include those selected from the group consisting of homopolymers of polypropylene, copolymers and terpolymers of propylene with one or more comonomers selected from α-olefins having from 2-17 carbons. Suitable polypropylene copolymers and terpolymers include random or block propylene and ethylene copolymers or random or block propylene/ethylene/butene terpolymers. Suitable propylene and a-olefin copolymers are sold by Basell under the tradename PRO FAX, PRO FAX ULTRA and CATALLOY.

The present invention also contemplates using blends of propylene containing polymers as the second component of the film. In a preferred form of the invention the blends include at least a first propylene containing polymer and a second propylene containing polymer. The first propylene containing polymer and the second propylene containing polymer can be selected from the propylene homopolymer, copolymers and terpolymers set forth above. In a preferred form of the invention the first propylene containing polymer differs from the second propylene containing polymer in at least one of two ways. The first difference is the first propylene containing polymer preferably should have a melt flow rate of from about 3 times greater and more preferably from about 5 times greater than the melt flow rate of the second propylene containing polymer. The second difference is the first propylene-containing polymer preferably has a melting point from at least about 5° C. higher and more preferably from at least about 10° C. higher than that of the second propylene containing polymer. The melting point is measured in accordance with ASTM D3417 (Enthalpies of Fusion and Crystallization of Polymers by Differential Scanning Calorimetry). The first propylene containing polymer can differ from the second propylene containing polymer by the first difference, by the second difference or by both.

Suitable homopolymer and copolymers of cyclic olefins and bridged polycyclic hydrocarbons and films thereof can be found in U.S. Pat. Nos. 5,218,049, 5,854,349, 5,863,986, 5,795,945, 5,792,824; and European Patent numbers EP0 291,208,EP0 283,164,EP 0 497,567 which are incorporated in their entirety herein by reference and made a part hereof.

In a preferred form of the invention, suitable cyclic olefin monomers are monocyclic compounds having from 5 to about 10 carbons in the ring. The cyclic olefins can be selected from the group consisting of substituted and unsubstituted cyclopentene, cyclopentadiene, cyclohexene, cyclohexadiene, cycloheptene, cycloheptadiene, cyclooctene, cyclooctadiene. Suitable substituents include lower alkyl, acrylate derivatives and the like.

In a preferred form of the invention, suitable bridged polycyclic hydrocarbon monomers have two or more rings and more preferably contain at least 7 carbons. The rings can be substituted or unsubstituted. Suitable substitutes include lower alkyl, aryl, aralkyl, vinyl, allyloxy, (meth)acryloxy and the like. The bridged polycyclic hydrocarbons are selected from the group consisting of those disclosed in the above incorporated patents and patent applications. Suitable bridged polycyclic hydrocarbon containing polymers are sold by Ticona under the tradename TOPAS, by Nippon Zeon under the tradename ZEONEX and ZEONOR, by Daikyo Gomu Seiko under the tradename CZ resin, and by Mitsui Petrochemical Company under the tradename APEL.

In a preferred form of the present invention a monolayered film formed from one of the above blends will have the following physical characteristics: (1) a modulus of elasticity when measured in accordance with ASTM D882 of less than about 60,000 psi, (2) an internal haze when measured in accordance with ASTM D1003 of less than about 25%, (3) self adhesion ranking greater than about two as defined below, (4) essentially no adhesion to overpouch materials, (5) has a sample creep at 120° C. at about 27 psi loading of less than or equal to 150%, and (6) the film can be heat sealed into a container having seals wherein the seals remain intact when a liquid-filled container is autoclaved at 121° C. for one hour.

The film is also sufficiently flexible to construct flowable material containers. The film has a modulus of elasticity of less than about 60,000 psi, more preferably less than about 40,000 psi, even more preferably less than about 30,000 and most preferably less than about 20,000 psi when measured in accordance with ASTM D-882. When the flowable material container is an I.V. container it is desirable the container collapse or substantially collapse upon draining, and, therefore, should have a modulus of elasticity of less than about 40,000 psi, more preferably less than about 30,000 psi, and even more preferably less than about 20,000 when measured in accordance with ASTM D-882.

For the purposes of this invention, self-adhesion is defined as the tendency of the film to adhere to itself during autoclaving. This property can be determined with the following test. Film strips are cut 8″×2″, with the larger dimension in the machine direction. These strips are rolled into 2″ long tubes approximately 0.5″ in diameter. The wound film is held in place by compressing the film layers together at one end with a paper clip. The tubes are then placed in a steam autoclave at 121° C. for 30 minutes. The samples are allowed to cool for at least one hour. The film is then unwound. The resistance to unwinding and relative damage to the film is ranked as shown in Table 1 as follows:

Table 1

Rank Observed Result

(1) The film cannot be unwound without destroying the film.

(2) The film is difficult to peel and significant surface damage results.

(3) Some resistance to peeling and minor surface damage are noted.

(4) Slight resistance to peeling noted with little or no surface damage.

(5) No peel resistance and no surface damage noted.

Ranks are determined by three or more individuals and recorded as an average.

Adhesion to over pouch materials is determined by the following qualitative test. One inch wide strips of film are sealed into typical over pouch bags (medium or high density polyethylene). The over pouch bag is then placed into a laboratory autoclave at 252° F. and 24.5 psig gauge pressure for one hour. After autoclaving, the bags are cut open and the strips removed. If the films separate from the over pouch without leaving damage marks on the film surface, a ranking of no adhesion (N) is given. If the film separation produces visible damage, a ranking is given (Y) indicating that tack to the over pouch is present. A ranking to indicate slight adhesion (S) can also be given.

Creep properties were determined at 120° C. by clamping film strips having a thickness from about 5 mils to about 15 mils in a temperature controlled oven and loading with weights to produce a stress of about 27 psi. After loading for 40 minutes, the film strips were removed and the dimensional changes in a pre-marked one inch gap were recorded.

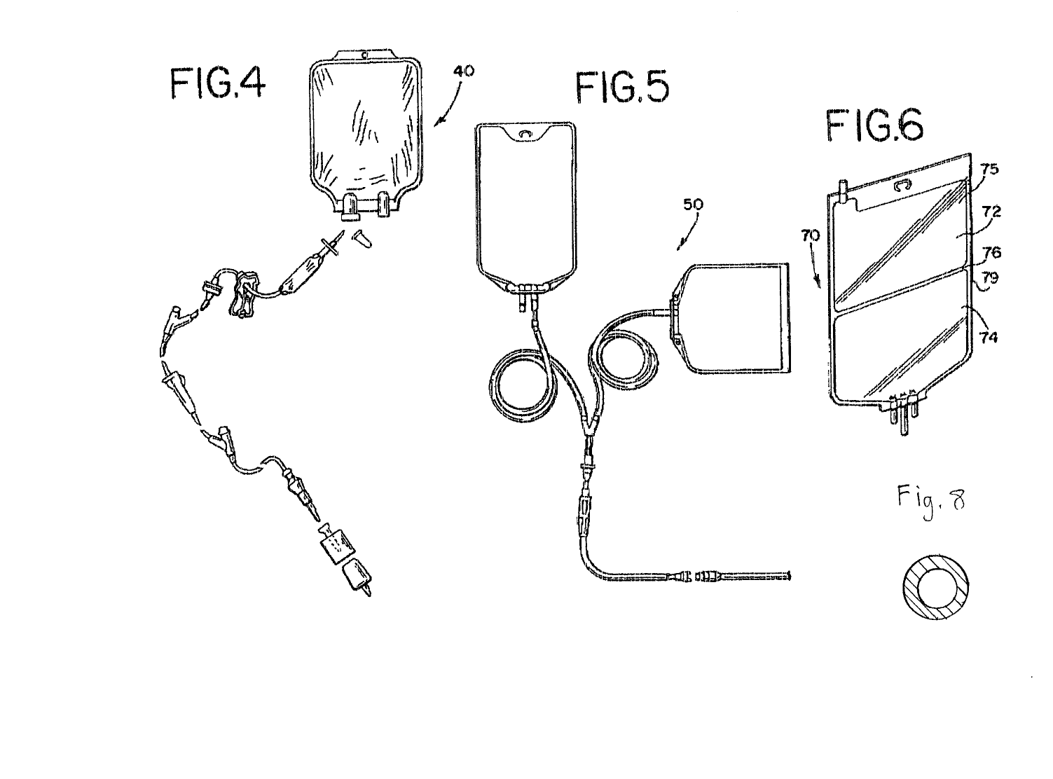

The film is capable of being sealed using standard heat sealing techniques. An adequate heat seal is formed when a fluid container, such as the one shown in FIG. 3, is fabricated from the film by sealing peripheral edges to define a centrally disposed fluid chamber. The container is filled with water and subjected to a standard autoclave sterilization process. Adequate heat seals remain intact upon completion of the autoclave cycle.

The films of the present invention have a haze of less than about 25% and most preferably less than about 15% when measured in accordance with ASTM D1003. For the purposes of this invention, internal haze is defined as the haze value measured when both film surfaces have been wetted with isopropyl alcohol.

b. Second Polymer Blends and Cross-linking

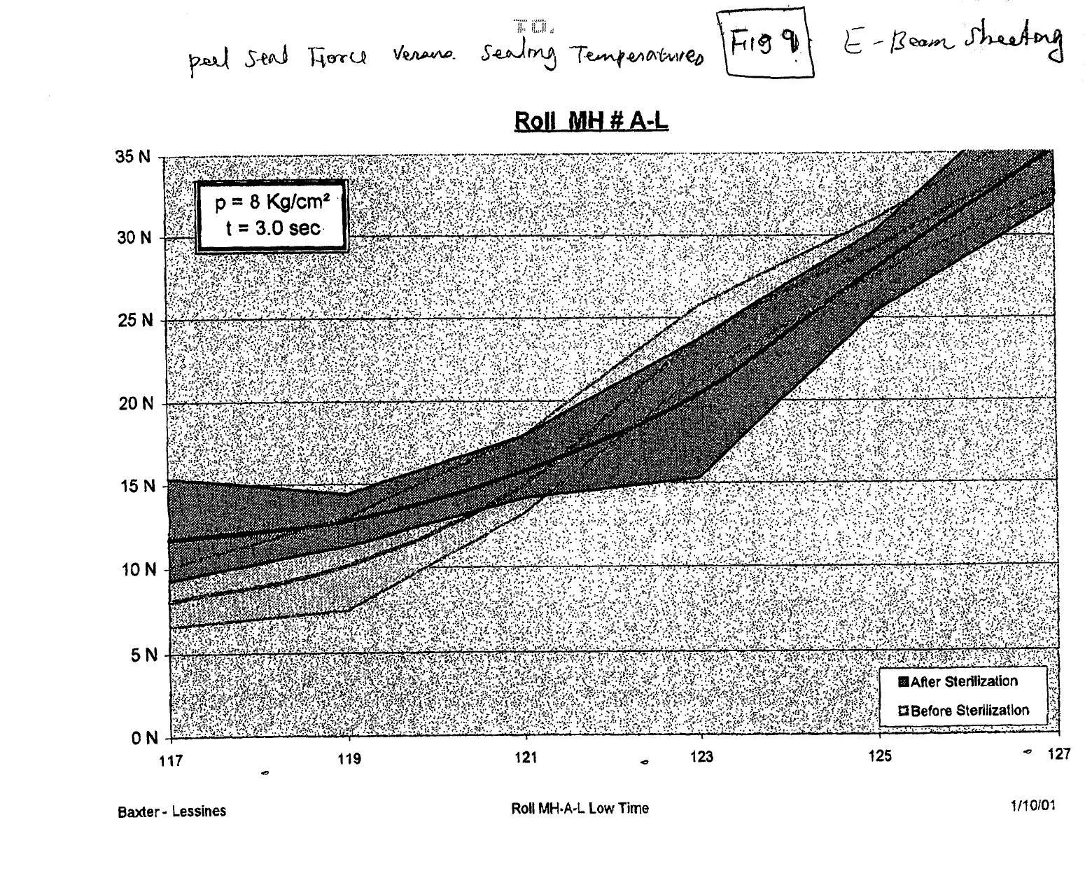

The present invention also provides other polymer blends suitable for fabricating a monolayer film, a multilayer film, a peel-seal film, a food or medical product container, a multichamber container, a multichamber peel seal container, an I.V. bag, a dialysis container, a nutritional-fluids container, and the like. The polymer blends have at least two components. The first component is a readily cross-linkable polymer and more preferably an ethylene-containing polymer. The second component is a non-readily cross-linkable polymer and more preferably a propylene-containing polymer. The blend is exposed to radiation to cross-link the first component but not the second component. The first component has a first melting point temperature determined by differential scanning calorimetry (DSC) and the second component has a second melting point temperature determined by DSC that is higher than the first melting point temperature. (See FIG. 7)

What is meant by the term cross-link is chemical linkages formed between different polymer molecules or between different segments of the same polymer molecule. Cross-linked polymers will show a significant increase in melt viscosity from a non-cross-linked version of the same polymer. What is meant by the term “readily cross-linkable polymer” is a polymer that can be cross-linked using standard cross-linking techniques. What is meant by “standard cross-linking techniques” are those polymer processing techniques that are well known in the art Standard cross-linking techniques includes: (1) radiation exposure type cross-linking techniques, and (2) chemical-exposure type cross-linking techniques. Radiation-exposure type cross-linking techniques includes exposing a polymer to: gamma radiation, electron beam radiation, ultra-violet radiation or electromagnetic energy in other frequency ranges that are effective to cause cross-linking. Chemical-exposure cross-linking techniques include using peroxides, silanes, multifunctional acrylates, sulfur or other chemical cross-linking agents effective to cause cross-linking.

What is meant by the term “non-readily cross-linkable polymer” is a polymer that does not increase substantially in weight average molecular weight when exposed to the cross-linking techniques set forth above.

The first component is present in an amount by weight of the polymer blend from a minimum point starting from about 50% and successively incrementally increasing by 5% the minimum point (i.e., 55%, 60%, 65%. etc.) to a maximum of 95%. Thus, for example, the first range is from about 50% to about 95%. The second range is from about 55% to about 95% and the final range is from about 90% to about 95%. In yet another preferred form of the invention the first component will be present in an amount by weight of from about 55% to about 90%, more preferably from about 60% to about 80%, and even more preferably from about 65% to about 75%.

The first component can be a single ethylene-containing polymer or a blend of two or more ethylene containing polymers which in sum constitute by weight the ranges set forth for the first component. The melting point temperature of such a blend will show a single distinct composite melting point or a peak for each ethylene-containing polymer of the blend or a combination of the same.

Suitable ethylene-containing polymers include those selected from the group consisting of ethylene homopolymers and ethylene copolymers set forth above. Suitable ethylene and α-olefin copolymers will have a density of less than about 0.915 g/cc, more preferably less than about 0.905 g/cc, and most preferably less than about 0.900 g/cc. Suitable polymers include, but are not limited to, ultra low-density polyethylene (ULDPE), ethylene-propylene rubber (EPR), and ethylene propylene diene terpolymer (EPDM). Preferably, the ethylene-containing polymers are those sold by Dow Chemical Company under the AFFINITY tradename, most preferably Affinity PL 1880 and VP 8770, and by Dupont-Dow under the ENGAGE tradename, most preferably Engage 8003.

The second component will constitute the remaining weight-percent portion of the blends and will be present singularly or in sum the converse weight percentage ranges from those set forth above for the first component. Accordingly, if the first component is present from about 50% to about 95% the second component or the sum of the additional components will be the converse or from about 5% to about 50%.

The second component may be a single propylene-containing polymer or a single methyl-pentene-containing polymer. The second component can also be a blend of two or more propylene-containing polymers, two or more methyl-pentene-containing polymers or a blend of at least one propylene-containing polymer and at least one methyl-pentene-containing polymer.

Suitable propylene-containing polymers include those selected from the group consisting of homopolymers of polypropylene, copolymers and terpolymers of propylene with one or more comonomers selected from α-olefins having from 2-18 carbons. Suitable polypropylene copolymers and terpolymers include random or block propylene and ethylene copolymers or random or block propylene/ethylene/butene terpolymers. Suitable propylene and α-olefin copolymers are sold by Basell under the tradename PRO FAX, preferably PRO FAX SA-861 and by Exxon as Exxon PP3505GE1. In a preferred form of the invention, the second component will have a distinct melting point temperature, a distinct composite melting point temperature or a melting point temperature associated with each of the sub-components of the second component, or a combination of the same, determined by DSC of equal to or higher than about 135° C. Further, in a preferred form of the invention the first component will have a modulus of elasticity of less than about 200,000 psi, more preferably less than about 150,000 psi, and most preferably less than about 100,000 psi.

Suitable methylpentene-containing polymers include homopolymers of 4-methylpentene-1; copolymers and terpolymers of methylpentene with one or more comonomers selected from α-olefins having from 2-18 carbons. A preferred methylpentene-containing polymer is sold by Mitsui Petrochemical, Ltd. under the tradename TPX™.

In a preferred form of the invention the first component will constitute what is known as the continuous phase and the second component or other additional components will constitute a dispersed phase or dispersed phases as the case may be.

The second component of the polymer blend is selected from the group consisting of propylene-containing polymers and methylpentene-containing polymers. The second component is present in the amounts set forth above.

It is also contemplated additional polymer processing components can be added to the blends of the present invention. For example it may be desirable to add a fatty acid amide or diatomaceous earth. Suitable fatty amides include those derived from fatty acids having from 10 to 30 carbons and most preferably is derived from erucic acid.

The second polymer blend can be fabricated into a monolayer film using standard polymer processing techniques such as extrusion.

Referring now to FIG. 7 showing a plot from a differential scanning calorimeter of a two-component polymer blend of the present invention fabricated into a monolayer film. The first melting point temperature and the second melting point temperature are referred to respectively as 100 and 102. The temperature range from and including the first melting point temperature 100 to a point just lower than the second melting point temperature 102 defines a peel seal heat sealing window 104 wherein die sealing temperatures will provide a peel seal and at temperatures above the second melting point temperature and below the temperature where the polymer burns will provide a permanent seal.

This material property allows for formation of both peel seals and permanent seals using the same film. For example, a monolayer film of the present invention can be folded upon itself to define a layered structure having both a peel seal in a first location and a permanent seal in a second location spaced a distance from the first location.

II. Polymer and Film Processing

To produce the films of the present invention from the above-described polymer blends, raw materials are fed into an extrusion hopper at the desired mix ratio employing weight feeders. The materials are extruded using an extrusion die to produce a mono-layer film. The film is irradiated with a suitable energy source and then sealed to form a fluid container. The raw materials can also be pre-compounded before extrusion employing a single screw, twin screw or other compounding methods familiar to those skilled in the art. Other polymer processing techniques may also be used to fabricate the film, either sheet film or tube film, of the present invention including blow molding, blown extrusion, thermoforming, calendaring, compression molding or other polymer processing techniques well known in the art.

The film can be cross-linked using standard cross-linking techniques including: (1) radiation exposure type cross-linking techniques, (2) chemical-exposure type cross-linking techniques or (3) a combination of both techniques. Radiation-exposure type cross-linking techniques includes exposing a polymer to: gamma radiation, electron beam radiation, ultra-violet radiation or electromagnetic energy in other frequency ranges that are effective to cause cross-linking. Chemical-exposure cross-linking techniques include using peroxides, silares, multifunctional acrylates, sulfur, or other chemical cross-linking agents.

The preferred method of irradiating the film is to expose it to an electron beam with beam energy from about 150 Kev-10 Mev, more preferably from 200-300 Kev and a dosage from about 20 kGys to about 200 kGys and more preferably from about 60-150 kGys. To reduce or minimize the oxidative degradation of the film during and subsequent to electron beam exposure, it is desirable to reduce the partial pressure of oxygen in the area surrounding the film being exposed to the radiation. The oxygen partial pressure may be reduced by applying a vacuum or by applying another gas such as nitrogen under pressure or other known techniques for accomplishing this goal. In a preferred form of the invention the oxygen concentration during a nitrogen flush is less than about 400 ppm, more preferably less than about 100 ppm and more preferably less than about 40 ppm.

III. Multilayer Films

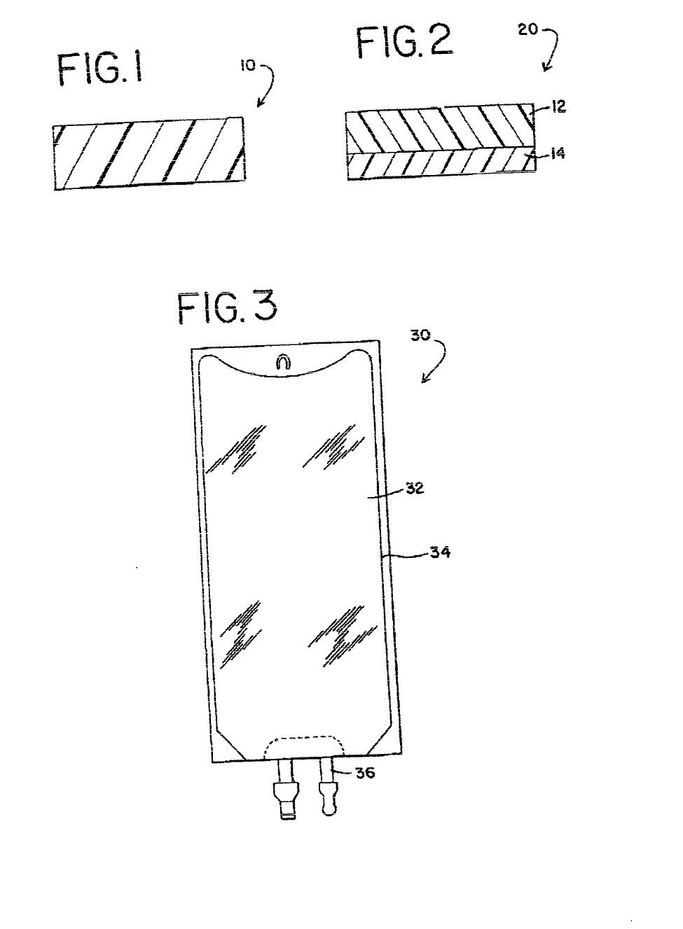

FIG. 2 shows an example of a multilayer film 20 including layer 12 of the mono-layer described above. In a preferred form of the invention the monolayer shall be the seal layer. The multilayer film 20 can include any additional layer 14 or combination of additional layers selected from layers such as a skin layer, a radio frequency susceptible layer, a water vapor barrier layer, a gaseous barrier layer, a scrap layer, a seal layer and a core layer to name a few.

The skin layer can be added to increase the scuff resistance of the film. The skin layer can be an olefin material such as homopolymers and copolymers of propylene and ethylene. The skin layer may also be a polyester, copolyester, polyamide or copolyamide. The term “copolyester” and the like is applied to polyesters synthesized from more than one diol and a dibasic acid. Copolyesters as used herein may also be characterized as copolymers of polyether and polyethylene terephthalate. More preferably copolyesters as used herein may be characterized as polymeric materials derived from 1,4 cyclohexane dimethanol, 1,4 cyclohexane dicarboxylic acid, and polytetramethylene glycol ether, or equivalents of any of the above, as reactants. Suitable copolyesters therefore include polyester ethers such as PCCE.

Suitable water vapor barriers include but are not limited to HDPE, MDPE and polyester (PET, PBT, PEN, etc.)

Suitable gaseous barriers are those that inhibit the passage of oxygen, carbon dioxide or other gasses. Suitable gas barriers include but are not limited to polyesters, EVOH, and polyamides.

Scrap material generated prior to irradiation can be incorporated into one or more layers.

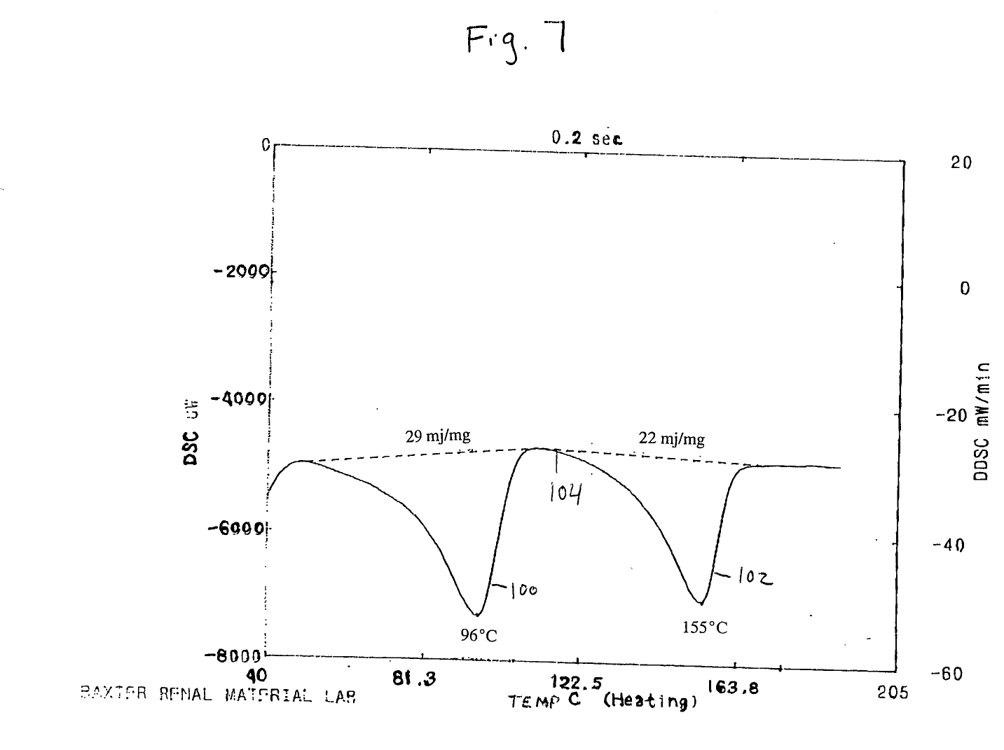

IV. Flowable Material Containers FIG. 3 shows a flowable materials container and particularly an I.V. container 30 made from a monolayer film or a multilayered film described above. FIG. 4 shows an I.V. administration set 40 and FIG. 5 shows a peritoneal dialysis set 50 fabricated from the polymer blends of the present invention. The present invention further contemplates fabricating medical tubing (FIG. 8) from the blends of the present invention. It is contemplated that the radiation treatment of tubing will differ from films due to the increased thickness and round shape of tubing but tubing can be effectively treated within the radiation energy ranges set forth above for the film.

What is meant by “flowable material” is a material that will flow by the force of gravity. Flowable materials therefore include both liquid items and powdered, lyopholized or granular items and the like.

The container 30 has sidewalls 32 placed in registration and sealed along peripheral edges to form a permanent peripheral seal 33 to define a chamber 34 for containing flowable materials such as fluids or granular material. For containers made through blow molding only or blown extrusion process longitudinal edges would be sealed to complete the container. A port tube 36 or multiple port tubes are provided to fill and empty the contents of the container 30. The sidewalls and port tube can be fabricated from one of the monolayer or multiple layered films set forth above. Surprisingly, the medical articles fabricated from the blends and films described above can be heat sealed even though the film has been irradiated with electron beam radiation.

In a preferred form of the invention, the film and containers will be capable of withstanding a steam sterilization process of up to at least 130° C. and more preferably from about 100° C. to about 126° C. and even more preferably from about 100° C. to about 121° C. Heat seals can be achieved using standard heat sealing techniques known to those skilled in the art.

V. Multi-Chamber Containers Incorporating Peel Seal

FIG. 6 shows a dual chamber container 70 having a first chamber 72 and a second chamber 74 separated by a peelable seal 76. The container sidewalls 75 are fabricated from one of the polymer blends, monolayer films or multiple layered films set forth above. Dual chamber containers can be used for numerous applications such as separately housing two components for mixing later. Typically, one of the chambers will contain a liquid. By pressing on the container sidewall 75 over the liquid containing chamber the liquid contents will flow toward the peelable seal 76 and by applying sufficient pressure the seal 76 will rupture to allow mixing of the components stored in the separate chambers.

While FIG. 6 shows only one peelable seal 76, it is contemplated that numerous peelable seals could be provided to create numerous chambers. Further, FIG. 6 shows the peelable seal running between lateral edges. It is also contemplated that the peelable seals could extend between longitudinal edges or simply around an area not intersecting the permanent peripheral seam 33 to define a chamber.

The peelable seal 76 may be created simultaneously with sealing the peripheral sidewalls or before or after the creation of the permanent peripheral seals. The peelable seal 76 can be created by controlling sealing conditions. Peelable seals can be created with the application of lower temperature and pressure than employed to provide the permanent peripheral seal 33 or by shortening the sealing times from that used to provide the permanent seal or the like. Further enhancement of the peel characteristics can be obtained with localized modification of the film surface characteristics (corona or other suitable treatment). It is contemplated that the container can be sealed using ultrasonic welding techniques, conduction heat sealing techniques and other sealing techniques well-known in the art.

The present invention contemplates that a peelable seal can be formed between films of the present invention. It is also contemplated that the films of the present invention can be peel sealed to other polymeric films, paper products or metal foils. It is further contemplated the films and sealing techniques disclosed herein can be used to form peel seals between materials which would otherwise not be capable of forming a peel seal. This can be accomplished by attaching the films of the present invention to the material not suitable for forming a peel seal along a line where the peel seal is to be formed and then sealing along the line where the peel seal material is present.

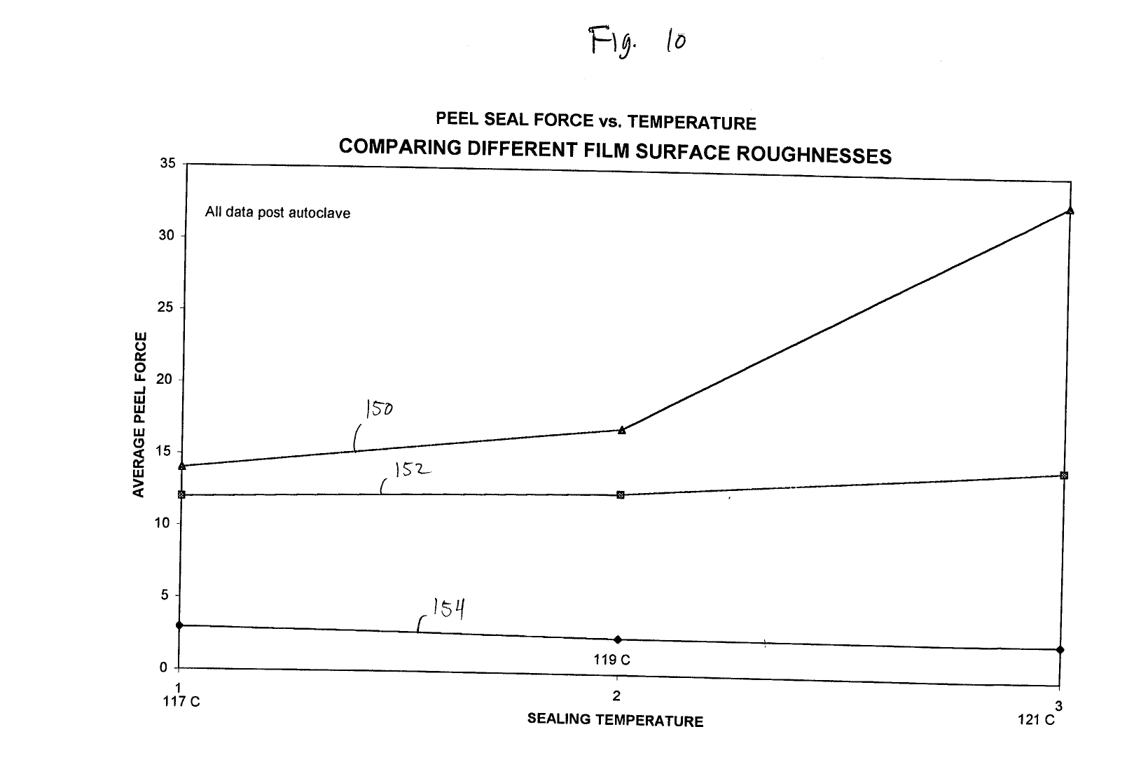

According to a preferred form of the invention, the peel seal 76 is formed by sealing the peal seal 76 at a temperature in the peel seal heat sealing window 104 positioned between the first and second melting point temperatures 100 and 102 respectively. For instances where the first component is a blend of more than one ethylene-containing polymer having more than one distinct melting point peak the peel seal heat sealing window 104 will extend between the higher melting point temperature peak of the first component to the lowest melting point peak of the second component. In a preferred form of the invention, the peel seal heat sealing window 104 will include a temperature used to steam sterilize the films or containers made therefrom. The peel seal heat-sealing window should include temperatures from about 75° C. to about 135° C., more preferably from about 100° C. to about 130° C. and even more preferably from about 110° C. to about 125° C. It has been found that in sealing at various temperatures within the peel seal heat sealing window provide a nearly constant or essentially constant peel strength. Further, it has been found that it is possible to achieve a nearly constant peel strength when comparing a peel seal formed by sealing in the heat sealing window before and after the autoclaving or steam sterilization process (FIG. 9). What is meant by nearly constant or essentially constant is that the strength of the peelable seal increases or decreases by less than about 30%, more preferably less than about 20% and most preferably less than about 10% before and after autoclaving when sealed at a temperature in the peel seal heat sealing window 104.

In a preferred form of the invention the peel seals of the present invention will be capable of adhesive release as opposed to cohesive release. The term adhesive release means the peel seal can be activated (peeled apart) and the line along which the peel seal existed has no visible fibrils or other visible particulate matter remaining from the material that formed the seal. The term cohesive release is meant to refer to a peel seal that upon activation has visible fibrils or other particulate matter in the general area where the peel seal extended prior to activation.

Additionally, the present invention contemplates that the films could be subjected to a sealing process at a temperature above the second melting point temperature to form a permanent seal. In instances where there is more than one propylene-containing polymers having two or more distinct melting points then a permanent seal can be formed by a sealing process above the lower of the propylene melting point temperatures.

VI. Surface Texture

The present invention further provides for optionally providing the films with a surface texture or roughness. The amount of surface roughness can be quantified by surface haze values measured by ASTM 1003 and by profilometer roughness Ra values. These films were also tested for peel seal strength before and after autoclaving.

The internal haze is determined after wetting with isopropyl alcohol. The surface haze is total haze-internal haze. Profilometer readings are measured by a Sheffield Profilometer (Warner & Swasey) with a type G tracer. Ra is roughness average value—the arithmetic average height if roughness irregularities measured from a mean line within the evaluate length (L)

where Ra=1/L∫₀^{L}IyI dx

FIG. 10 shows a plot of three films having varying amounts of surface texture but otherwise of the same material. The first plot 150 has a low surface roughness, plot 152 has a medium surface roughness and plot 154 has a high surface roughness. Peel seal strengths of these films were measured by taking two films of the same material, positioning them in registration and forming a weld within the temperatures of the peel seal window. The films were peeled using an Instron device and the strength required to peel the seal was reported.

To form a peel seal it is desirable to have an average peel seal strength of less than about 50 N/15 mm, more preferably less than about 40 N/15 mm and even more preferably less than about 30 N/15 mm. The peel seal should also have a peel strength in excess of about 3 N/15 mm.

Surface roughness can be imparted on the film using textured rollers or other such technique well known in the art.

### VII. EXAMPLES

### First Set of Examples

The films identified in the tables below were fabricated into a monolayer film using an extrusion process. The film was exposed to electron beam radiation having an acceleration voltage of from 200 Kev to 300 Kev for a dose set forth in the tables that follows:

TABLE 2

| FORMULA | 1 | 2 | 3 | 4 | 5 | 6 | 7 | 8 | 9 | 10 |
|---|---|---|---|---|---|---|---|---|---|---|
| DuPont/Dow | 100 | 95 | 90 | 80 | | | | | | 70 |
| Engage 8003 | | | | | | | | | | |
| Dow Affinity PL-1880 | | | | | 100 | 95 | 90 | 80 | 70 | |
| Exxon PP3505GE1 | | 5 | 10 | 20 | | | | | | |
| Basell SA-861 | | | | | | 5 | 10 | 20 | 30 | 20 |
| Basell SG-982 | | | | | | | | | | 10 |
| Self adhesion rank - 100 kGy | 1 | 2 | 3.7 | 4 | 1 | NA | 1 | 2 | 4 | NA |
| 150 kGy | 1 | 2 | 4.5 | 5 | 1 | NA | 1.3 | 2.3 | 3.3 | NA |
| 200 kGy | 1 | 3.3 | 4.7 | 5 | 1 | 1.7 | 2 | 2 | 4 | NA |
| Tack to over pouch - 100 kGy | Y | S | N | N | Y | NA | Y | S | N | NA |
| 150 kGy | Y | S | N | N | Y | NA | Y | N | N | NA |
| 200 kGy | Y | S | N | N | Y | NA | Y | N | N | NA |
| 120° C. Creep (%) 0 kGy | NA | NA | NA | NA | NA | NA | Melts | NA | 550 | NA |
| 100 kGy | 200 | 138 | 88 | 41 | 263 | NA | 216 | 98 | 28 | NA |
| 150 kGy | 63 | 38 | 31 | 18 | 43 | NA | 31 | 25 | 13 | NA |
| 200 kGy | 25 | 13 | 16 | 16 | 21 | 22 | 16 | 9 | 22 | NA |
| Autoclavability 100 kGy | NA | NA | Y | Y | NA | NA | NA | Y | Y | Y |
| 150 kGy | NA | NA | Y | Y | NA | NA | NA | Y | Y | Y |
| Internal Haze (ASTM | 1 | 1.2 | 1.6 | 2.8 | 2.7 | 2.7 | 3.5 | 4.3 | 4.8 | 2.2 |
| D1003) | | | | | | | | | | |
| Tensile modulus (psi) | 2860 | 3800 | 6650 | 16260 | 6110 | NA | 12830 | 19810 | 28820 | 21060 |
| (ASTM D882) | | | | | | | | | | |

Dow Affinity PL 1880 is a ULDPE having a density of 0.902 g/cc.
DuPont Dow Engage 8003 is a ULDPE having a density of 0.885 g/cc.
Exxon PP305GE1 is a homopolymer of propylene (MFR 440).
Montell SA-861 is a propylene and ethylene copolymer (MFR 6.5).
Montell SA 982 is a propylene and ethylene copolymer (MER 100).
“NA” means not available.

### Second Set of Examples

Table 3 contains data on a peelable seal formed from two monolayer films of the same material. The monolayer films were exposed to electron beam radiation having an acceleration voltage of from 250 Kev for a dose of 120 KGys.

TABLE 3

| Formula | 11 | 12 |
|---|---|---|
| DuPont-Dow Engage 8003 or | 40 | 40 |
| Dow Affinity VP 8770 | | |
| Dow Affinity PL1880 | 25 | 25 |
| 1^{ST} ™ (° C.) by DSC | 94 | 94 |
| Exxon PP 3505GE1 | 5 | — |
| Basell SA-861 | 30 | 35 |
| 2^{nd} ™ (° C.) by DSC | 153 | 148 |
| Peel Seal Strength (Newton/15 mm) | 15-17 | 18-20 |
| Before Autoclaving^{#} | | |
| Peel Seal Strength (Newton/15 mm) | 15-16 | 18-19 |
| After Autoclaving^{#} | | |

^{#}: Peel seal was conducted at about 121 C.

### Third Set of Examples

FIG. 10 shows a plot of three films having varying amounts of surface haze and profilometer measurements. Films having the formulations reported in Table 4 were placed in registration with one another and a heat seal was formed at 121° C. The amount of force to separate the seal was measured on an Instron and is tabulated in Table 4 below. These examples demonstrate the effect surface texture has on peel seal strength. It can be seen from the data, as the surface roughness increases the peel seal force decreases.

TABLE 4

| Formula | 13 | 12 | 14 |
|---|---|---|---|
| DuPont-Dow Engage 8003 or | 40 | 40 | 40 |
| Dow Affinity VP 8770 | | | |
| Dow Affinity PL1880 | 25 | 25 | 25 |
| 1^{ST} ™ (° C.) by DSC | 94 | 94 | 94 |
| Basell SA-861 | 35 | 35 | 35 |
| 2^{nd} ™ (° C.) by DSC | 148 | 148 | 148 |
| Profilometer Roughness Ra Value | 7-9 | 17-21 | 28-30 |
| (micro-inch) | | | |
| Surface Haze (%) | 0.8 | 5-7 | 17.3 |
| (ASTM D1003) | | | |
| Peel Seal Strength (Newton/15 mm) | 28-30 | 18-20 | 6-6.5 |
| Before Autoclaving | | | |
| Peel Seal Strength (Newton/15 mm) | 29-32 | 18-19 | 6-7 |
| After Autoclaving | | | |

While the specific embodiment has been illustrated and described, numerous modifications come to mind without significantly departing from the spirit of the invention and the scope of protection is only limited by the scope of the accompanying Claims.

We claim:

1. A polymer blend comprising:
a first component of a polymeric material capable of being cross-linked and selected from the group consisting of an ethylene containing polymer, the first component present in an amount by weight of the blend from about 50% to about 95%, the first component having a first melting point temperature determined by DSC;
a second component not readily cross-linkable and selected from the group consisting of propylene-containing polymers and methyl-pentene-containing polymers, the second component being present in an amount by weight of the blend from about 50% to about 5%, the second component having a second melting point temperature determined by DSC; and
a portion of the first component being cross-linked and the second component is essentially free of cross-linking.

2. The blend of claim 1, wherein the second melting point temperature is higher than the first melting point temperature.

3. The blend of claim 2 when formed into a film the film is capable of forming a peel seal to itself when heated to below the second melting point temperature.

4. The blend of claim 2 is capable of forming a peel seal to itself when heated to above the first melting point temperature but below the second melting point temperature.

5. The blend of claim 3 when formed into a film the film is capable of forming a permanent seal to itself when heated to above the second melting point temperature.

6. The blend of claim 1 is capable of being sterilized by steam at a temperature from about 100° C. to about 130° C.

7. The blend of claim 2, wherein a peel seal heat sealing window is defined between a range of temperatures existing between the first melting point temperature and the second melting point temperature.

8. The blend of claim 7, wherein the peel seal heat sealing window includes at least one temperature point within a range of temperatures suitable for steam sterilization.

9. The blend of claim 7, wherein the peel seal window includes at least one temperature point within the range of from about 75° C. to about 135° C.

10. The blend of claim 1, wherein the ethylene-containing polymer is selected from the group consisting of: ethylene homopolymers, and ethylene copolymers.

11. The blend of claim 10, wherein the ethylene copolymer is obtained by reacting ethylene with a comonomer selected from the group consisting of: α-olefins, vinyl esters, vinyl carboxylic acids, alkyl substituted vinyl esters, alkyl substituted vinyl carboxylic acids, acrylic acids, ester derivatives of acrylic acids, alkyl substituted acrylic acids, ester derivatives of alkyl substituted acrylic acids and ion stabilized alkyl substituted acrylic acids.

12. The blend of claim 11, wherein the ethylene and α-olefin copolymer has a density of less than about 0.915 g/cc

13. The blend of claim 12, wherein the ethylene copolymer is obtained using a single-site catalyst.

14. The blend of claim 1, wherein the propylene containing polymer is selected from the group consisting of propylene homopolymers and propylene copolymers.

15. The blend of claim 14, wherein the propylene containing polymer has a modulus of elasticity of less than about 200,000 psi.

16. The blend of claim 1, wherein the methylpentene-containing polymer is selected from the group consisting of: homopolymers of 4-methylpentene-1, and copolymers of 4-methylpentene-1.

17. The blend of claim 1, wherein the first component is present in an amount by weight of from about 55% to about 90%.

18. The blend of claim 1, wherein the first component is present in an amount by weight of from about 60% to about 80%.

19. The blend of claim 1, wherein the first component is present in an amount by weight of from about 65% to about 75%.

20. The blend of claim 1, wherein the first component is a blend of ethylene containing polymers.

21. The blend of claim 1, wherein the second component is a blend selected from the group consisting of at least one propylene-containing polymer, at least one methyl-pentene-containing polymer, and at least one propylene-containing polymer and at least one methyl-pentene-containing polymer.

22. A monolayer film comprising:
a polymer blend of a first component of a polymeric material capable of being cross-linked and selected from the group consisting of an ethylene containing polymer, the first component present in an amount by weight of the film from about 50% to about 95%, the first component having a first melting point temperature determined by DSC, a second component not readily cross-linkable and selected from the group consisting of propylene containing polymers and methyl pentene containing polymers, the second component being present in an amount by weight of the film from about 50% to about 5%, the second component having a second melting point temperature determined by DSC; and a portion of the first component being cross-linked and the second component is essentially free of cross-linking.

23. The film of claim 22, wherein the second melting point temperature is higher than the first melting point temperature.

24. The film of claim 22 is capable of forming a peel seal to itself when heated to above the first melting point temperature but below the second melting point temperature.

25. The film of claim 24 is capable of forming a permanent seal to itself when heated above the second melting point temperature.

26. The film of claim 22 is capable of being sterilized by steam at a temperature from about 100° C. to about 130° C.

27. The film of claim 23, wherein a peel seal heat sealing window is defined between a range of temperatures existing between the first melting point temperature and the second melting point temperature.

28. The film of claim 27, wherein the peel seal heat sealing window includes at least one temperature point within a range of temperatures suitable for steam sterilization.

29. The film of claim 27, wherein the peel seal heat sealing window includes at least one temperature point within the range of from about 75° C. to about 135° C.

30. The film of claim 22 is capable of forming a peel seal with itself that is capable of adhesive release.

31. The film of claim 22, wherein the ethylene containing polymer is selected from the group consisting of: ethylene homopolymers, and ethylene copolymers.

32. The film of claim 31, wherein the ethylene copolymer is obtained by reacting ethylene with a comonomer selected from the group consisting of: α-olefins, vinyl esters, vinyl carboxylic acids, alkyl substituted vinyl esters, alkyl substituted vinyl carboxylic acids, acrylic acids, ester derivatives of acrylic acids, alkyl substituted acrylic acids, ester derivatives of alkyl substituted acrylic acids and ion stabilized alkyl substituted acrylic acids.

33. The film of claim 32, wherein the ethylene and α-olefin copolymer has a density of less than about 0.915 g/cc.

34. The film of claim 33, wherein the ethylene copolymer is obtained using a single-site catalyst.

35. The film of claim 22, wherein the propylene-containing polymer is selected from the group consisting of propylene homopolymers and propylene copolymers.

36. The film of claim 22, wherein the methylpentene-containing polymer is selected from the group consisting of: homopolymers of 4-methylpentene-1, and copolymers of 4-methylpentene-1.

37. The film of claim 35, wherein the propylene containing polymer has a modulus of elasticity of less than about 200,000 psi.

38. The film of claim 22, wherein the first component is a blend of ethylene containing polymers.

39. The film of claim 22, wherein the second component is a blend selected from the group consisting of at least one propylene-containing polymer, at least one methyl-pentene-containing polymer, and at least one propylene-containing polymer and at least one methyl-pentene-containing polymer.

40. A multiple layered film comprising:
a first layer of a first polymer blend of a first component of a polymeric material capable of being cross-linked and selected from the group consisting of an ethylene containing polymer, the first component present in an amount by weight of the blend from about 50% to about 95%, the first component having a first melting point temperature determined by DSC, a second component not readily cross-linkable and selected from the group consisting of propylene containing polymers and methyl-pentene containing polymers, the second component being present in an amount by weight of the blend from about 50% to about 5%, the second component having a second melting point temperature determined by DSC; and a portion of the first component being cross-linked and the second component is essentially free of cross-linking; and
a second layer attached to the first layer and being of a polymer, paper, or metal foil.

41. The film of claim 40, wherein the second melting point temperature is higher than the first melting point temperature.

42. The film of claim 40 is capable of forming a peel seal to itself when heated to above the first melting point temperature but below the second melting point temperature.

43. The film of claim 42 is capable of forming a permanent seal to itself when heated to above the second melting point temperature.

44. The film of claim 40 is capable of being sterilized by steam at a temperature from about 100° C. to about 130° C.

45. The film of claim 40, wherein a peel seal window is defined between a range of temperatures existing between the first melting point temperature and the second melting point temperature.

46. The film of claim 45, wherein the peel seal window includes at least one temperature point within a range of temperatures suitable for steam sterilization.

47. The film of claim 45, wherein the peel seal heat sealing window includes at least one temperature point within the range of from about 75° C. to about 135° C.

48. The film of claim 40 is capable of forming a peel seal with itself that is capable of adhesive release.

49. The film of claim 40, wherein the ethylene containing polymer is selected from the group consisting of: ethylene homopolymers, and ethylene copolymers.

50. The film of claim 49, wherein the ethylene copolymer is obtained by reacting ethylene with a comonomer selected from the group consisting of: α-olefins, vinyl esters, vinyl carboxylic acids, alkyl substituted vinyl esters, alkyl substituted vinyl carboxylic acids, acrylic acids, ester derivatives of acrylic acids, alkyl substituted acrylic acids, ester derivatives of alkyl substituted acrylic acids and ion stabilized alkyl substituted acrylic acids.

51. The film of claim 40, wherein the ethylene and α-olefin copolymer has a density of less than about 0.915 g/cc.

52. The film of claim 40, wherein the ethylene copolymer is obtained using a single-site catalyst.

53. The film of claim 40, wherein the propylene-containing polymer is selected from the group consisting of propylene homopolymers and propylene copolymers.

54. The film of claim 53, wherein the propylene containing polymer has a modulus of elasticity of less than about 200,000 psi.

55. The film of claim 40, wherein the methylpentene-containing polymer is selected from the group consisting of: homopolymers of 4-methylpentene-1, and copolymers of 4-methylpentene-1.

56. The film of claim 40, wherein the first component is a blend of ethylene containing polymers.

57. The film of claim 40, wherein the second component is a blend selected from the group consisting of at least one propylene containing polymer, at least one methyl-pentene-containing polymer, and at least one propylene containing polymer with at least one methyl-pentene-containing polymer.

58. The film of claim 40, further comprising a third layer attached to the second layer opposite the first layer.

59. The film of claim 58, wherein the third layer is of a second polymer blend.

60. The film of claim 59, wherein the second polymer blend comprises a third component of a polymeric material capable of being cross-linked and selected from the group consisting of an ethylene containing polymer, the third component present in an amount by weight of the blend from about 50% to about 95%, the third component having a third melting point temperature determined by DSC, a fourth component not readily cross-linkable and selected from the group consisting of propylene containing polymers and methyl pentene containing polymers, the fourth component being present in an amount by weight of the blend from about 50% to about 5%, the fourth component having a fourth melting point temperature determined by DSC; and a portion of the third component being cross-linked and the fourth component is essentially free of cross-linking.

61. A tubing comprising:
a sidewall of a polymer blend of a first component of a polymeric material capable of being cross-linked and selected from the group consisting of an ethylene containing polymer, the first component present in an amount by weight of the blend from about 50% to about 95%, the first component having a first melting point temperature determined by DSC, a second component not readily cross-linkable and selected from the group consisting of propylene containing polymers and methyl-pentene containing polymers, the second component being present in an amount by weight of the blend from about 50% to about 5%, the second component having a second melting point temperature determined by DSC; and a portion of the first component being cross-linked and the second component is essentially free of cross-linking.

62. The tubing of claim 61, wherein the second melting point temperature is higher than the first melting point temperature.

63. The tubing of claim 61 is capable of forming a peel seal to itself when heated to a temperature below the second melting point temperature.

64. The tubing of claim 63 is capable of forming a permanent seal to itself when heated to above the second melting point temperature.

65. The tubing of claim 61, wherein a peel seal heat sealing window is defined between the first melting point temperature and the second melting point temperature.

66. The tubing of claim 65, wherein the peel seal heat sealing window includes at least one temperature within the range of from about 75° C. to about 135° C.

67. The tubing of claim 65, wherein the peel seal heat sealing window includes at least one temperature point within a range of temperatures suitable for steam sterilization.

68. The tubing of claim 67, wherein the peel seal window includes at least one temperature point within the range of from about 100° C. to about 130° C.

69. The tubing of claim 61 is capable of forming a peel seal with itself that is capable of adhesive release.

70. The tubing of claim 61, wherein the ethylene containing polymer is selected from the group consisting of: ethylene homopolymers, and ethylene copolymers.

71. The tubing of claim 70, wherein the ethylene copolymer is obtained by reacting ethylene with a comonomer selected from the group consisting of: α-olefins, vinyl esters, vinyl carboxylic acids, alkyl substituted vinyl esters, alkyl substituted vinyl carboxylic acids, acrylic acids, ester derivatives of acrylic acids, alkyl substituted acrylic acids, ester derivatives of alkyl substituted acrylic acids and ion stabilized alkyl substituted acrylic acids.

72. The tubing of claim 71, wherein the ethylene and α-olefin copolymer has a density of less than about 0.915 g/cc.

73. The tubing of claim 70, wherein the ethylene copolymer is obtained using a single-site catalyst.

74. The tubing of claim 61, wherein the propylene containing polymer is selected from the group consisting of propylene homopolymers and propylene copolymers.

75. The tubing of claim 74, wherein the propylene containing polymer has a modulus of elasticity of less than about 200,000 psi.

76. The tubing of claim 61, wherein the methylpentene-containing polymer is selected from the group consisting of: homopolymers of 4-methylpentene-1, and copolymers of 4-methylpentene-1.

77. The tubing of claim 61, wherein the first component is a blend of ethylene containing polymers.

78. The tubing of claim 61, wherein the second component is a blend selected from the group containing of at least one propylene containing polymer, at least one methyl-pentene containing polymer, and at least one propylene container polymer with at least one methylpentene-containing polymer.

79. A flowable materials container comprising:
a first sidewall of a first polymer blend of a first component of a polymeric material capable of being cross-linked and selected from the group consisting of an ethylene-containing polymer, the first component present in an amount by weight of the first blend from about 50% to about 95%, the first component having a first melting point temperature determined by DSC, a second component not readily cross-linkable and selected from the group consisting of propylene containing polymers and methyl-pentene containing polymers, the second component being present in an amount by weight of the first blend from about 50% to about 5%, the second component having a second melting point temperature determined by DSC; and a portion of the first component being cross-linked and the second component is essentially free of cross-linking; and
a second sidewall attached to the first sidewall along a peripheral seam to define a chamber between the first sidewall and the second sidewall, the second sidewall being of a polymer, a paper or a metal foil.

80. The container of claim 79, wherein the second sidewall is of a second polymer blend.

81. The container of claim 80, wherein the second polymer blend is the same as the first polymer blend.

82. The container of claim 79, further comprising a peel seal between the first sidewall and the second sidewall.

83. The container of claim 82, wherein the peel seal separates the chamber into a first sub-chamber and a second sub-chamber.

84. The container of claim 82, wherein the peel seal is capable of adhesive release.

85. The container of claim 82, wherein the peel seal extends between lateral edges of the container.

86. The container of claim 82, wherein the peel seal extends between longitudinal edges of the container.

87. The container of claim 82, wherein the peripheral seam is a permanent seal.

88. The container of claim 82, wherein the peel seal is formed by heating the first sidewall to above the first melting point temperature but below the second melting point temperature.

89. The container film of claim 88, wherein the permanent seal is formed by heating the first sidewall to above the second melting point temperature.

90. The container of claim 79 is capable of being sterilized by steam at a temperature from about 100° C. to about 130° C.

91. The container of claim 79, wherein the second melting point temperature is higher than the first melting point temperature, and wherein a peel seal heat sealing window is defined between a range of temperatures existing between the first melting point temperature and the second melting point temperature.

92. The container of claim 91, wherein the peel seal heat sealing window includes at least one temperature point within a range of temperatures suitable for steam sterilization.

93. The container of claim 91, wherein the peel seal heat sealing window includes at least one temperature point within the range of from about 75° C. to about 135° C.

94. The container of claim 79, wherein the ethylene-containing polymer is selected from the group consisting of: ethylene homopolymers, and ethylene copolymers.

95. The container of claim 94, wherein the ethylene copolymer is obtained by reacting ethylene with a comonomer selected from the group consisting of: α-olefins, vinyl esters, vinyl carboxylic acids, alkyl substituted vinyl esters, alkyl substituted vinyl carboxylic acids, acrylic acids, ester derivatives of acrylic acids, alkyl substituted acrylic acids, ester derivatives of alkyl substituted acrylic acids and ion stabilized alkyl substituted acrylic acids.

96. The container of claim 95, wherein the ethylene and α-olefin copolymer has a density of less than about 0.915 g/cc.

97. The container of claim 96, wherein the ethylene copolymer is obtained using a single-site catalyst.

98. The container of claim 79, wherein the propylene-containing polymer is selected from the group consisting of propylene homopolymers and propylene copolymers.

99. The container of claim 98, wherein the propylene-containing polymer has a modulus of elasticity of less than about 200,000 psi.

100. The container of claim 98, wherein the methylpentene-containing polymer is selected from the group consisting of: homopolymers of 4-methylpentene-1, and copolymers of 4-methylpentene-1.

101. The container of claim 79, wherein the first component is a blend of ethylene containing polymers.

102. The container of claim 79, wherein the second component is a blend selected from the group consisting of at least one propylene-containing polymer, at least one methyl-pentene containing polymer, and at least one propylene-containing polymer with at least one methylpentene-containing polymer.

103. A multichamber flowable materials container comprising:
a first sidewall of a first polymer blend of a first component of a polymeric material capable of being cross-linked and selected from the group consisting of an ethylene-containing polymer, the first component present in an amount by weight of the first blend from about 50% to about 95%, the first component having a first melting point determined by DSC, a second component not readily cross-linkable and selected from the group consisting of propylene containing polymers and methyl pentene containing polymers, the second component being present in an amount by weight of the first blend from about 50% to about 5%, the second component having a second melting point temperature determined by DSC; and a portion of the first component being cross-linked and the second component is essentially free of cross-linking;
a second sidewall attached to the first sidewall along a peripheral seam to define a chamber between the first sidewall and the second sidewall, the second sidewall being of a polymer, a paper or a metal foil; and
a peelable seal between the first sidewall and the second sidewall and dividing the chamber into two subchambers.

104. The container of claim 103, wherein the peelable seal is capable of an adhesive release.

105. The container of claim 103, wherein the peelable seal is capable of being separated with a force of greater than about 3 N/15 mm.

106. The container of claim 103, wherein the container is capable of being steam sterilized.

107. The container of claim 106, wherein the peel seal has substantially the same strength when comparing the strength of the peel seal before the container is steam sterilized with the strength of the peel seal after the container is steam sterilized.

108. The container of claim 107, wherein the strength of the peel seal before steam sterilization and after steam sterilization varies by less than 30%.

109. The container of claim 107, wherein the strength of the peel seal before steam sterilization and after steam sterilization varies by less than 20%.

110. The container of claim 107, wherein the strength of the peel seal before steam sterilization and after steam sterilization varies by less than 10%.

111. A method for forming a film comprising the steps of:
providing a polymer blend of a first component of a polymeric material capable of being cross-linked and selected from the group consisting of an ethylene-containing polymer, the first component present in an amount by weight of the blend from about 50% to about 95%, the first component having a first melting point temperature determined by DSC, a second component not readily cross-linkable and selected from the group consisting of propylene containing polymers and methyl pentene containing polymers, the second component being present in an amount by weight of the blend from about 50% to about 5%, the second component having a second melting point temperature determined by DSC;
forming the polymer blend into a film; and
cross-linking the first component while the second component is essentially free of cross-linking.

112. The method of claim 111, wherein the step of forming comprises a polymer processing technique selected from the group consisting of extrusion, blown extrusion, thermoforming, calendaring, compression molding and blow molding.

113. The method of claim 111, wherein the film is a monolayer film.

114. The method of claim 111, wherein the film is a multiple-layer film.

115. A method for forming a multiple-chamber container comprising the steps of:
providing a first film of a polymer blend of a first component of a polymeric material capable of being cross-linked and selected from the group consisting of an ethylene-containing polymer, the first component present in an amount by weight of the blend from about 50% to about 95%, the first component having a first melting point temperature determined by DSC, a second component not readily cross-linkable and selected from the group consisting of propylene containing polymers and methyl pentene containing polymers, the second component being present in an amount by weight of the blend from about 50% to about 5%, the second component having a second melting point temperature determined by DSC, the second melting point temperature being higher than the first melting point temperature;
providing a second film of a polymeric material, paper or metal foil;
cross-linking the first component while the second component is essentially free of cross-linking;
positioning the first film into registration with the second film;
sealing a first portion of the first film to the second film to form a permanent seal; and
sealing a second portion of the first film to the second film to form a peel seal.

116. The method of claim 115, wherein the step of sealing the first portion comprises the steps of sealing about a peripheral portion of the first film and the second film to define a chamber.

117. The method of claim 116, wherein the step of sealing about a peripheral portion of the first film comprises the step of heating the first film to a temperature higher than the second melting point temperature.

118. The method of claim 115, wherein the peel seal divides the chamber into two subchambers.

119. The method of claim 115, wherein the step of sealing a second portion of the first film to the second film to define a peel seal comprises the step of heating the first film to a temperature higher than the first melting point temperature but less than the second melting point temperature.

120. The method of claim 115, wherein a peel seal heat sealing window is defined between the first melting point temperature and the second melting point temperature, wherein the step of sealing a second portion of the first film to the second film to define a peel seal comprises the step of heating the first film to a temperature within the peel seal window.

121. The method of claim 120, wherein the peel seal heat sealing window includes temperatures from about 75° C. to about 135° C.

122. The method of claim 115, wherein the step of cross-linking comprises the step of exposing the first film to a chemical cross-linking agent or to a radiation cross-linking source or to both a chemical cross-linking agent and a radiation cross-linking source.

123. The method of claim 122, wherein the chemical cross-linking agent is selected from the group consisting of: peroxides, silanes, sulfur, and multifunctional acrylates.

124. The method of claim 122, wherein the radiation cross-linking source is selected from the group consisting of: ultra-violet light, electron beam, and gamma rays.

125. The method of claim 115, wherein the step of forming a permanent seal is carried out before the step of forming the peel seal.

126. The method of claim 115, wherein the step of forming a permanent seal is carried out after the step of forming the peel seal.

127. The method of claim 115, wherein the cross-linking step is carried out before the step of sealing a first portion of film.

128. The method of claim 115, wherein the step of forming a permanent seal is carried out simultaneously with the step of forming the peel seal.

129. A multichamber flowable materials container comprising:
a first sidewall of a first polymer blend of a first component of a polymeric material capable of being cross-linked and selected from the group consisting of an ethylene-containing polymer, the first component present in an amount by weight of the first blend from about 50% to about 95%, the first component having a first melting point temperature determined by DSC, a second component not readily cross-linkable and selected from the group consisting of propylene containing polymers and methyl-pentene-containing polymers, the second component being present in an amount by weight of the first blend from about 50% to about 5%, the second component having a second melting point temperature determined by DSC; and a portion of the first component being cross-linked and the second component is essentially free of cross-linking;
a second sidewall attached to the first sidewall along a peripheral seam to define a chamber between the first sidewall and the second sidewall, the second sidewall being of a polymer, a paper or a metal foil;
a peelable seal between the first sidewall and the second sidewall and dividing the chamber into two subchambers; and
wherein the peelable seal can be opened by applying a force to the container and wherein the force remains essentially constant when comparing the peelable seal of the container before the container has been autoclaved and after the container has been autoclaved.

130. The container of claim 129, wherein the force required to open the peelable seal prior to the autoclave process and after the autoclave process varies by less than 30%.

131. The container of claim 129, wherein the force required to open the peelable seal prior to the autoclave process and after the autoclave process varies by less than 20%.

132. The container of claim 129, wherein the force required to open the peelable seal prior to the autoclave process and after the autoclave process varies by less than 10%.

133. The container of claim 132, wherein the peelable seal is capable of being separated with a force of greater than about 3 N/15 mm.

134. The container of claim 129 wherein a range of temperatures extends between the first melting point temperature and the second melting point temperature to define a peel seal heat sealing window.

135. The container of claim 134 wherein the peelable seal strength remains essentially constant when sealed within the peel seal heat sealing window.

136. A layered structure comprising:
a first layer and a second layer of a material not capable of forming a peel seal; and
a third layer of a material capable of forming a peel seal interposed between the first layer and the second layer to form a peel seal between the first layer and the second layer.

137. A method for forming a textured film comprising the steps of:
providing a polymer blend of a first component of a polymeric material capable of being cross-linked and selected from the group consisting of an ethylene-containing polymer, the first component present in an amount by weight of the blend from about 50% to about 95%, the first component having a first melting point temperature determined by DSC, a second component not readily cross-linkable and selected from the group consisting of propylene containing polymers and methyl pentene containing polymers, the second component being present in an amount by weight of the blend from about 50% to about 5%, the second component having a second melting point temperature determined by DSC;
forming the polymer blend into a film;
imparting a textured surface on the film; and
cross-linking the first component while the second component is essentially free of cross-linking.

138. The method of claim 137 wherein the step of imparting a textured surface on the film comprises the step of extruding the film.

139. The method of claim 137 wherein the step of extruding the film includes the step of running the film in contact with a textured roller.

140. The method of claim 137 wherein a peel seal heat sealing window is defined between the first melting point temperature and the second melting point temperature, the method further comprising the steps of:
placing a portion of the film in registration with another portion of the film to define an overlap area;
heating the overlap area to a temperature within the peel seal heat sealing window to define a peel seal.

141. The method of claim 140 wherein the peel seal has a strength that remains essentially constant when sealed within the peel seal heat sealing window.

142. The method of claim 140 wherein the peel seal has a strength that remains essentially constant when comparing the film before being autoclaved and after being autoclaved.

143. The method of claim 140 wherein the surface texture can be measured by haze values and wherein as the haze values increase the peel seal strength decreases.

144. The method of claim 140 wherein the surface texture can be measured by surface roughness values and wherein as the surface roughness values increase the peel seal strength decreases.
